(19) United States
(12) Patent Application Publication
(10) Pub. No.: US 2018/0330884 A1
(43) Pub. Date: Nov. 15, 2018

(54) MULTILAYER CERAMIC CAPACITOR AND BOARD HAVING THE SAME

(71) Applicant: SAMSUNG ELECTRO-MECHANICS CO., LTD., Suwon-si (KR)

(72) Inventors: Han Nah CHANG, Suwon-si (KR); Tea Youl YOU, Suwon-si (KR); Mi Young KIM, Suwon-si (KR)

(21) Appl. No.: 15/824,742

(22) Filed: Nov. 28, 2017

(30) Foreign Application Priority Data
May 12, 2017 (KR) 10-2017-0058991

(51) Int. Cl. H01G 4/30; H01G 4/12; H01G 4/01; H01G 2/06

(52) U.S. Cl. CPC H01G 4/30; H01G 2/065; H01G 4/01; H01G 4/12

(57) ABSTRACT

A multilayer ceramic capacitor includes: a body including an active layer in which first and second internal electrodes are alternately stacked with respective dielectric layers interposed therebetween, an upper cover layer formed on the active layer, a lower cover layer formed beneath the active layer and having a thickness greater than that of the upper cover layer, and an identifying layer formed beneath the lower cover layer; and third and fourth internal electrodes alternately stacked in the lower cover layer with the respective dielectric layers interposed therebetween. The multilayer ceramic capacitor is arranged such that (B+C)/A>1.041, in which A is ½ of an overall thickness of the body, B is a sum of thicknesses of the lower cover layer and the identifying layer, C is ½ of an overall thickness of the active layer, D is a thickness of the upper cover layer.

### CROSS-REFERENCE TO RELATED APPLICATION(S)

This application claims the benefit of priority to Korean Patent Application No. 10-2017-0058991 filed on May 12, 2017 in the Korean Intellectual Property Office, the disclosure of which is incorporated herein by reference in its entirety.

### BACKGROUND

### 1. Field

The present disclosure relates to a multilayer ceramic capacitor and a board having the same.

### 2. Description of Related Art

A multilayer ceramic capacitor, a multilayer chip electronic component, is a chip-type condenser mounted on the circuit boards of various electronic products such as an image display device, for example, a liquid crystal display (LCD), a plasma display panel (PDP), or the like, a computer, a smartphone, a cellular phone, and the like, to serve to charge or discharge electricity therein or therefrom.

A multilayer ceramic capacitor (MLCC) may be used as a component of various electronic apparatuses since it is relatively small, implements high capacitance, and is easily mounted.

The multilayer ceramic capacitor may have a structure in which a plurality of dielectric layers and internal electrodes, having different polarities and alternately disposed between the dielectric layers, are stacked.

In a package product in which the multilayer ceramic capacitor is mounted, when energy is applied to the multilayer ceramic capacitor, a predetermined level or more of heat and acoustic noise may be generated. In addition, the heat and the acoustic noise may be increased due to an interaction between internal components of the package product at the time of driving the package product.

Therefore, improvements of equivalent series inductance (ESL) characteristics for reducing heat and acoustic noise have been required.

### SUMMARY

An aspect of the present disclosure may provide a multilayer ceramic capacitor in which acoustic noise may be reduced and equivalent series inductance (ESL) characteristics may be secured, and a board having the same.

According to an aspect of the present disclosure, a multilayer ceramic capacitor may include: a body including an active layer in which first and second internal electrodes are alternately stacked with respective dielectric layers interposed therebetween, an upper cover layer formed on the active layer, a lower cover layer formed beneath the active layer and having a thickness greater than that of the upper cover layer, and an identifying layer formed beneath the lower cover layer; and third and fourth internal electrodes alternately stacked in the lower cover layer with the respective dielectric layers interposed therebetween. The multilayer ceramic capacitor is arranged such that (B+C)/A>1.041, where A is ½ of an overall thickness of the body, B is a sum of thicknesses of the lower cover layer and the identifying layer, C is ½ of an overall thickness of the active layer, D is a thickness of the upper cover layer.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a schematic perspective view illustrating a multilayer ceramic capacitor according to an exemplary embodiment in the present disclosure;

FIGS. 2 and 3 are schematic cross-sectional views illustrating the multilayer ceramic capacitor according to an exemplary embodiment in the present disclosure;

FIG. 4 is a perspective view illustrating a form in which the multilayer ceramic capacitor according to an exemplary embodiment in the present disclosure is mounted on a printed circuit board; and

FIG. 5 is a cross-sectional view illustrating the form in which the multilayer ceramic capacitor according to an exemplary embodiment in the present disclosure is mounted on the printed circuit board.

### DETAILED DESCRIPTION

Hereinafter, exemplary embodiments of the present disclosure will be described in detail with reference to the accompanying drawings.

Directions of a hexahedron will be defined in order to clearly describe exemplary embodiments in the present disclosure. L, W and T illustrated in the accompanying drawings refer to a length direction, a width direction, and a thickness direction, respectively. Here, the thickness direction refers to a stack direction in which dielectric layers are stacked.

Further, in the present exemplary embodiment, for convenience of explanation, opposite end surfaces refer to surfaces on which first and second external electrodes are formed in the length direction of a body, and side surfaces refer to surfaces vertically intersecting with the opposite end surfaces, respectively.

Multilayer Ceramic Capacitor

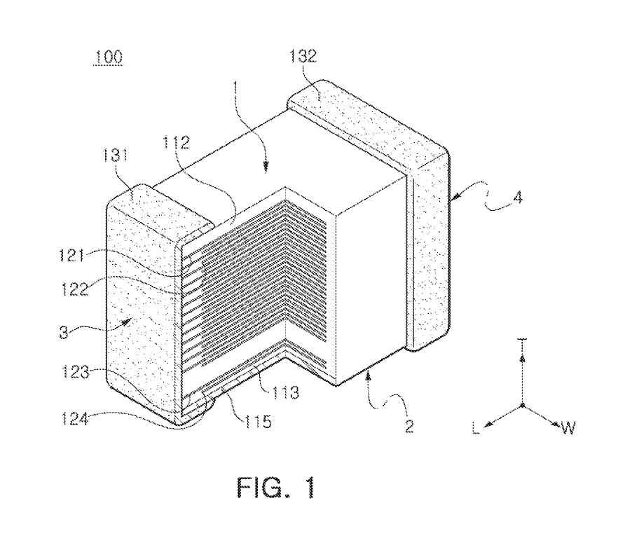

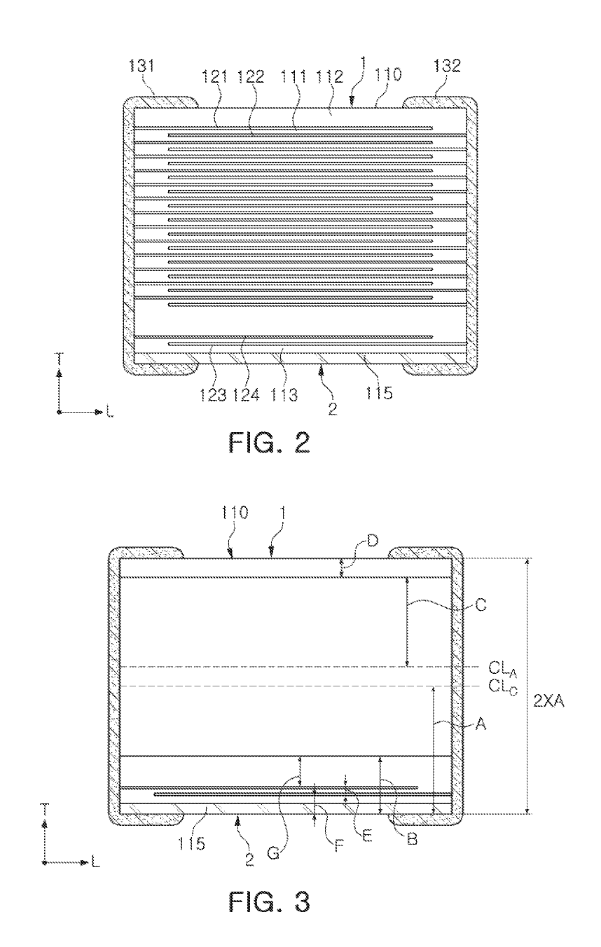

Referring to FIGS. 1 and 2, a multilayer ceramic capacitor 100 according to an exemplary embodiment in the present disclosure may include a body 110 including an active layer in which first and second internal electrodes 121 and 122 are alternately stacked with respective dielectric layers 111 interposed therebetween, an upper cover layer 112 formed on the active layer, a lower cover layer 113 formed beneath the active layer and having a thickness greater than that of the upper cover layer, and an identifying layer 115 formed beneath the lower cover layer, and third and fourth internal electrodes 123 and 124 alternately stacked in the lower cover layer with the respective dielectric layers interposed therebetween, wherein (B+C)/A>1.041 in which A is ½ of an overall thickness of the body, B is a sum of thicknesses of the lower cover layer and the identifying layer, C is ½ of an overall thickness of the active layer, D is a thickness of the upper cover layer, and (B+C)/A is a ratio in which a central portion of the active layer is outside of a central portion of the body.

The body 110 may be formed by stacking and then sintering a plurality of dielectric layers 111, and a shape and a dimension of the body 110 and the number of dielectric layers 111 stacked in the body 110 are not limited to those illustrated in the present exemplary embodiment.

In addition, the plurality of dielectric layers 111 forming the body 110 may be in a sintered state, and adjacent dielectric layers 111 may be integrated with each other so that boundaries therebetween are not readily apparent without using a scanning electron microscope (SEM).

The body 110 may include the active layer, which contributes to forming capacitance of the multilayer ceramic capacitor, the upper and lower cover layers 112 and 113 formed as upper and lower margin portions on and beneath the active layer, respectively, and the identifying layer 115.

The identifying layer 115 may be placed to identify an upper portion and a lower portion of the body 110 using a difference in brightness or color. The identifying layer 115 may be a dielectric layer in which a single ceramic green sheet is sintered or a plurality of ceramic green sheets are stacked. In a dielectric layer, becoming the identifying layer 115, one or more metals selected from nickel (Ni), manganese (Mn), chromium (Cr), and vanadium (V) are added thereto, so there may be a difference in brightness or a color outside the body 110.

The active layer may be formed by repeatedly stacking a plurality of first and second internal electrodes 121 and 122 with the respective dielectric layers 111 interposed therebetween.

Here, a thickness of the dielectric layer 111 may be arbitrarily changed in accordance with a capacitance design of the multilayer ceramic capacitor 100. For example, a thickness of one dielectric layer 111 after being sintered may be 0.01 to 1.00 μm. However, a thickness of one dielectric layer 111 is not limited thereto.

In addition, the dielectric layer 111 may include ceramic powders having a high dielectric constant, for example, barium titanate (BaTiO₃) based powders or strontium titanate (SrTiO₃) based powders. However, a material of the dielectric layer 111 is not limited thereto.

The upper and lower cover layers 112 and 113 may be formed of the same material as that of the dielectric layer 111 and have the same configuration as that of the dielectric layers 111 except that they do not include the internal electrodes.

The upper and lower cover layers 112 and 113 may be formed by stacking a single dielectric layer or two or more dielectric layers on upper and lower surfaces of the active layer, respectively, in the thickness direction, and may basically serve to prevent damage to the first and second internal electrodes 121 and 122 due to physical or chemical stress.

In addition, the number of dielectric layers stacked in the lower cover layer 113 may be more than that of dielectric layers stacked in the upper cover layer 112, such that the lower cover layer 113 may have a thickness greater than that of the upper cover layer.

Here, since equivalent series inductance (ESL) is in proportion to an area of a loop through which a current flows, when the thickness of the lower cover layer of the multilayer ceramic capacitor is increased as described above, vibrations of the internal electrodes may be reduced to reduce acoustic noise, but the ESL may be increased.

However, in the present exemplary embodiment, at least one pair of third and fourth internal electrodes 123 and 124 may be formed in the lower cover layer 113 to maintain the ESL at a predetermined level while reducing the acoustic noise as described above.

Such an ESL reduction preventing effect may be further improved when the third and fourth internal electrodes 123 and 124 formed in the lower cover layer 113 are formed adjacently to a lower end of the lower cover layer 113.

That is, the third and fourth internal electrodes 123 and 124 formed in the lower cover layer 113 may serve to reduce the area of the loop through which the current flows at the time of an operation of the multilayer ceramic capacitor to reduce the ESL of the multilayer ceramic capacitor.

The sum of the numbers of third and fourth internal electrodes formed in the lower cover layer may be 10 or more. When the sum of the numbers of third and fourth internal electrodes formed in the lower cover layer is less than 10, the loop through which the current flows may not be confirmed due to a phenomenon in which the internal electrodes are broken, such that an ESL improving effect may be significantly reduced.

The first and second internal electrodes 121 and 122, which are a pair of electrodes having different polarities, may be formed in the stacked direction of the dielectric layers 111 to be alternately exposed through the opposite end surfaces of the body by printing a conductive paste including a conductive metal at a predetermined thickness on the dielectric layers 111, and may be electrically insulated from each other by the respective dielectric layers 111 disposed therebetween.

That is, the first and second internal electrodes 121 and 122 may be electrically connected to first and second external electrodes 131 and 132 through portions alternately exposed through the opposite end surfaces of the body 110, respectively.

Therefore, when voltages are applied to the first and second external electrodes 131 and 132, electric charges may be accumulated between the first and second internal electrodes 121 and 122 facing each other. In this case, capacitance of the multilayer ceramic capacitor 100 may be in proportion to an area of a region in which the first and second internal electrodes 121 and 122 overlap each other.

Thicknesses of the first and second internal electrodes 121 and 122 may be determined depending on a purpose. For example, the thicknesses of the first and second internal electrodes 121 and 122 may be determined to be in a range of 0.2 to 1.0 μm in consideration of a size of the body 110. However, the thicknesses of the first and second internal electrodes 121 and 122 are not limited thereto.

In addition, the conductive metal included in the conductive paste forming the first and second internal electrodes 121 and 122 may be nickel (Ni), copper (Cu), palladium (Pd), or alloys thereof. However, the conductive metal is not limited thereto.

In addition, a method of printing the conductive paste may be a screen printing method, a gravure printing method, or the like. However, the method of printing the conductive paste is not limited thereto.

The first and second external electrodes 131 and 132 may be formed of a conductive paste including a conductive metal. Here, the conductive metal may be nickel (Ni), copper (Cu), palladium (Pd), gold (Au), or alloys thereof. However, the conductive metal is not limited thereto.

A relationship between dimensions of components included in the multilayer ceramic capacitor according to the present exemplary embodiment and acoustic noise will hereinafter be described.

Referring to FIG. 3, ½ of the overall thickness of the body 110 is defined as A, the sum of the thicknesses of the lower cover layer 113 and the identifying layer 115 is defined as B, ½ of the overall thickness of the active layer is defined as C, the thickness of the upper cover layer 112 is defined as D, a thickness of a region in which the third and fourth internal electrodes 123 and 124 are formed in the lower cover layer 113 is defined as E, a thickness from a lowermost internal electrode of the lower cover layer 113 to the lower surface of the identifying layer 115 is defined as F, and a thickness from a lowermost internal electrode of the active layer to an uppermost internal electrode the lower cover layer is defined as G.

Here, the overall thickness of the body 110 refers to a distance from an upper surface 1 of the body 110 to a lower surface 2 of the body 110, and the overall thickness of the active layer refers to a distance from an upper surface of a first internal electrode 121 formed at the uppermost portion of the active layer to a lower surface of a second internal electrode 122 formed at the lowermost portion of the active layer.

In addition, the sum B of the thicknesses of the lower cover layer 113 and the identifying layer 115 refers to a distance from the lower surface of the second internal electrode 122 formed at the lowermost portion of the active layer in the thickness direction to the lower surface 2 of the body 110, and the thickness D of the upper cover layer 112 refers to a distance from the upper surface of the first internal electrode 121 formed at the uppermost portion of the active layer in the thickness direction to the upper surface 1 of the body 110.

When voltages having different polarities are applied to the first and second external electrodes 131 and 132 formed on opposite end portions of the multilayer ceramic capacitor 100, the body 110 may be expanded and contracted in the thickness direction due to an inverse piezoelectric effect of the dielectric layers 111, and the opposite end portions of the first and second external electrodes 131 and 132 may be contracted and expanded as opposed to the expansion and the contraction of the body 110 in the thickness direction due to a Poisson effect.

Here, the central portion of the active layer, which is a portion expanded and contracted as much as possible at opposite end portions of the first and second external electrodes 131 and 132 in the length direction, may be factor causing the acoustic noise.

That is, in the present exemplary embodiment, in order to reduce the acoustic noise, points of inflection (PIs) formed on the opposite end surfaces of the body 110 may be formed on a level below a central portion CLC of the thickness of the body 110 due to a difference between a deformation rate generated at the central portion CLA of the active layer and a deformation rate generated in the lower cover layer 113 due to the application of the voltage.

In order to further reduce the acoustic noise, C>F>G>E in which C is ½ of the overall thickness of the active layer, E is the thickness of the region in which the internal electrodes are formed in the lower cover layer, F is the thickness from the lowermost internal electrode of the lower cover layer to the lower surface of the identifying layer, and G is a thickness from the lowermost internal electrode f the active layer to the uppermost internal electrode of the lower cover layer.

Here, in order to further reduce the acoustic noise, (B+C)/A>1.041 in which (B+C)/A is a ratio in which the central portion CLA of the active layer is out of the central portion CLC of the body 110.

In addition, a ratio (B/A) of the sum (B) of the thicknesses of the lower cover layer 113 and the identifying layer 115 to ½ (A) of the overall thickness of the body 110 may exceed 0.175 and be less than 0.38.

### Inventive Example

Multilayer ceramic capacitors according to Inventive Examples and Comparative Examples were manufactured as described below.

A slurry including powders such as barium titanate (BaTiO₃) powders, or the like, was applied to carrier films and was dried to prepare a plurality of ceramic green sheets having a thickness of 1 to 2 μm.

Then, a conductive paste for nickel internal electrodes was applied to the ceramic green sheets using a screen to form internal electrodes.

The ceramic green sheets were stacked in an amount of several hundreds. In this case, ceramic green sheets on which the internal electrodes are not formed were stacked in a larger amount below the ceramic green sheets on which the internal electrodes are formed than above the ceramic green sheets on which the internal electrodes are formed. Such a laminate was isostatically pressed under a pressure condition of 800 to 1200 kgf/cm² at 70 to 100° C.

The ceramic laminate of which the pressing is completed was diced in a form of individual chips, and the diced chips were maintained in air atmosphere at 170 to 260° C. for several tens of hours to be subjected to a de-binder process.

Then, the chips were sintered at 1150 to 1250° C. in a reduction atmosphere under oxygen partial pressure of 10⁻¹¹ to 10⁻¹⁰ atm lower than Ni/NiO equilibrium oxygen partial pressure, in order for the internal electrodes not to be oxidized. As a chip size of a multilayer chip capacitor after being sintered, length×width×thickness (L×W×T) was about 1.0 mm×0.5 mm×0.6 mm (L×W×T, 1005, 0.6T size). Here, a manufacturing tolerance was in a range of ±0.25 mm in length×width×thickness, and when the manufactured chip capacitors satisfied the manufacturing tolerance, acoustic noise of the manufactured multilayer ceramic capacitors was measured.

Next, processes such as a process of forming external electrodes, a plating process, and the like, were performed to manufacture multilayer ceramic capacitors.

TABLE 1

| | | | | | Capacitance |
|---|---|---|---|---|---|
| Sample | | | | | Implementation |
| No. | (B + C)/A | B/A | ESL (pH) | AN (dB) | Ratio |
| 1* | 1.041 | 0.175 | 320 | 16 | OK |
| 2* | 2.033 | 0.386 | 180 | 18 | NG |
| 3* | 1.041 | 0.193 | 300 | 15 | OK |
| 4* | 1.031 | 0.116 | 177 | 27 | OK |
| 5* | 0.994 | 0.153 | 181 | 26 | OK |
| 6 | 1.066 | 0.201 | 196 | 18 | OK |
| 7 | 1.050 | 0.199 | 178 | 18 | OK |
| 8 | 1.067 | 0.219 | 161 | 19 | OK |
| 9 | 1.126 | 0.212 | 193 | 20 | OK |
| 10 | 1.053 | 0.191 | 178 | 19 | OK |
| 11 | 1.051 | 0.191 | 172 | 20 | OK |
| 12 | 1.089 | 0.194 | 164 | 19 | OK |
| 13 | 1.105 | 0.217 | 188 | 20 | OK |
| 14 | 1.069 | 0.205 | 167 | 19 | OK |
| 15 | 1.103 | 0.193 | 165 | 18 | OK |
| 16 | 1.044 | 0.208 | 189 | 18 | OK |
| 17 | 1.043 | 0.195 | 192 | 16 | OK |
| 18 | 1.069 | 0.199 | 196 | 20 | OK |

Here, * indicates Comparative Example, and AN indicates acoustic noise.

The data in Table 1 was obtained by measuring dimensions of each capacitor from an image, captured by a scanning electron microscope (SEM), of a cross-section of each capacitor cut in a length-thickness direction (L-T) in a central portion of the body 110 of the multilayer ceramic capacitor 100 in the width direction of the body 110, as illustrated in FIG. 3.

Here, as described above, ½ of the overall thickness of the body 110 is defined as A, the sum of the thicknesses of the lower cover layer 113 and the identifying layer 115 is defined as B, ½ of the overall thickness of the active layer is defined as C, the thickness of the upper cover layer 112 is defined as D, the thickness of the region in which the third and fourth internal electrodes 123 and 124 are formed in the lower cover layer 113 is defined as E, the thickness from the lowermost internal electrode of the lower cover layer 113 to the lower surface of the identifying layer 115 is defined as F, and the thickness from the lowermost internal electrode of the active layer to the uppermost internal electrode of the lower cover layer is defined as G.

In order to measure acoustic noise, one sample (a multilayer chip capacitor) for each acoustic noise measuring board was mounted on a printed circuit board while upper and lower portions of the sample were distinguished from each other, and the board was mounted on a measuring jig.

Then, direct current (DC) voltages and voltage variations were applied to both terminals of the sample mounted on the measuring jig using a DC power supply and a function generator. Acoustic noise was measured through a microphone installed immediately above the printed circuit board.

A case in which acoustic noise exceeds 20 dB, noise that may be recognized by a user, or a case in which ESL exceeds 200 pH was classified into Comparative Example.

Here, in a case in which a value of (B+C)/A is substantially 1, it means that a central portion of the active layer is not significantly outside of a central portion of the body 110. Values of (B+C)/A of capacitors having a cover symmetry structure in which the thickness of the lower cover layer 113 and the thickness D of the upper cover layer 112 are substantially similar to each other were substantially 1.

When the value of (B+C)/A is greater than 1, it means that the central portion of the active layer is out of the central portion of the body 110 in an upward direction, and when the value of (B+C)/A is smaller than 1, it means that the central portion of the active layer is out of the central portion of the body 110 in a downward direction.

In addition, Samples 6 to 18 in which the ratio in which the central portion of the active layer is out of the central portion of the body 110, (B+C)/A exceeds 1.041 may have a structure in which the central portion of the active layer is out of the central portion of the body 110 in the upward direction.

In Table 1, Samples in which a capacitance implementation ratio (that is, a ratio of capacitance to target capacitance) is denoted by “NG” mean cases in which the ratio of capacitance to target capacitance is less than 80% when the target capacitance is 100%.

Therefore, even though the multilayer ceramic capacitor 100 according to the present exemplary embodiment has a structure of the lower cover layer 113 for reducing the acoustic noise, ESL of the multilayer ceramic capacitor 100 may be reduced to a level similar to that of ESL of a product according to the related art in which the lower cover layer 113 is not formed.

Board Having Multilayer Ceramic Capacitor

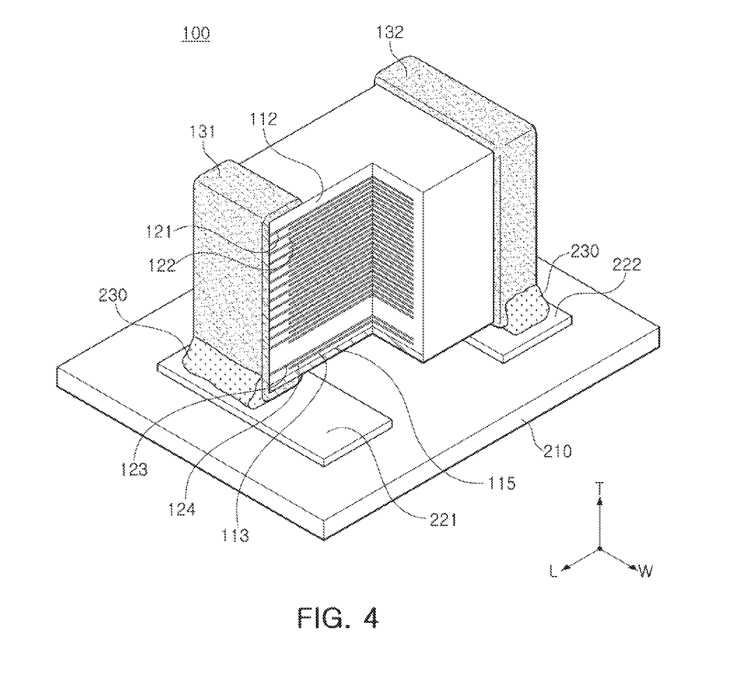

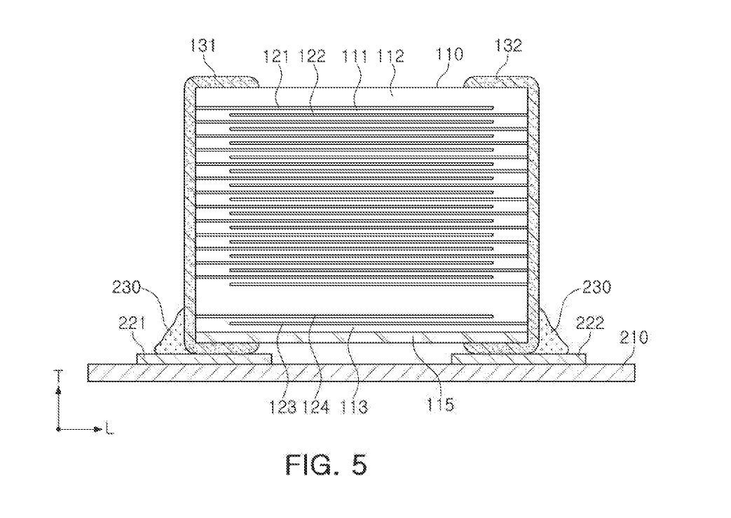

FIG. 4 is a perspective view illustrating a form in which the multilayer ceramic capacitor according to an exemplary embodiment in the present disclosure is mounted on a printed circuit board, and FIG. 5 is a cross-sectional view illustrating the form in which the multilayer ceramic capacitor according to an exemplary embodiment in the present disclosure is mounted on the printed circuit board.

A description for the same components as those illustrated in FIGS. 1 through 3 will be omitted.

Referring to FIGS. 4 and 5, a board having a multilayer ceramic capacitor 100 according to an exemplary embodiment in the present disclosure may include a printed circuit board 210 on which the multilayer ceramic capacitor 100 is horizontally mounted, first and second electrode pads 221 and 222 formed on an upper surface of the printed circuit board 210 to be spaced apart from each other.

Here, the multilayer ceramic capacitor 100 may be mounted on the printed circuit board 210 so that a first main surface of the body 110 thereof faces the printed circuit board 210, and may be electrically connected to the printed circuit board 210 by solders 230 in a state in which the first and second external electrodes 131 and 132 are positioned on the first and second electrode pads 221 and 222, respectively, to be in contact with the first and second electrode pads 221 and 222.

As set forth above, according to the exemplary embodiment in the present disclosure, the acoustic noise may be reduced, and ESL characteristics may be secured.

While exemplary embodiments have been shown and described above, it will be apparent to those skilled in the art that modifications and variations could be made without departing from the scope of the present invention as defined by the appended claims.

What is claimed is:

1. A multilayer ceramic capacitor comprising:
a body including an active layer in which first and second internal electrodes are alternately stacked with respective dielectric layers interposed therebetween, an upper cover layer formed on the active layer, a lower cover layer formed beneath the active layer and having a thickness greater than that of the upper cover layer, and an identifying layer formed beneath the lower cover layer; and
third and fourth internal electrodes alternately stacked in the lower cover layer with the respective dielectric layers interposed therebetween,
wherein (B+C)/A>1.041 in which A is ½ of an overall thickness of the body, B is a sum of thicknesses of the lower cover layer and the identifying layer, C is ½ of an overall thickness of the active layer, D is a thickness of the upper cover layer.

2. The multilayer ceramic capacitor of claim 1, wherein C>F>G>E in which C is ½ of the overall thickness of the active layer, E is a thickness of a region in which the internal electrodes are formed in the lower cover layer, F is a thickness from a lowermost internal electrode of the lower cover layer to a lower surface of the identifying layer, and G is a thickness from a lowermost internal electrode of the active layer to an uppermost internal electrode of the lower cover layer.

3. The multilayer ceramic capacitor of claim 1, wherein a ratio (B/A) of the sum (B) of the thicknesses of the lower cover layer and the identifying layer to ½ (A) of the overall thickness of the body exceeds 0.175 and is less than 0.38.

4. The multilayer ceramic capacitor of claim 1, wherein a thickness from the active layer to an internal electrode positioned in a lowermost portion of the lower cover layer is smaller than a width of the body.

5. A board having a multilayer ceramic capacitor, comprising:
a printed circuit board having first and second electrode pads disposed thereon; and
the multilayer ceramic capacitor installed on the printed circuit board,
wherein the multilayer ceramic capacitor includes a body including an active layer in which first and second internal electrodes are alternately stacked with respective dielectric layers interposed therebetween, an upper cover layer formed on the active layer, a lower cover layer formed beneath the active layer and having a thickness greater than that of the upper cover layer, and an identifying layer formed beneath the lower cover layer, and third and fourth internal electrodes alternately stacked in the lower cover layer with the respective dielectric layers interposed therebetween, and
(B+C)/A>1.041 in which A is ½ of an overall thickness of the body, B is a sum of thicknesses of the lower cover layer and the identifying layer, C is ½ of an overall thickness of the active layer, D is a thickness of the upper cover layer.

6. The board having a multilayer ceramic capacitor of claim 5, wherein C>F>G>E in which C is ½ of the overall thickness of the active layer, E is a thickness of a region in which the internal electrodes are formed in the lower cover layer, F is a thickness from a lowermost internal electrode of the lower cover layer to a lower surface of the identifying layer, and G is a thickness from a lowermost internal electrode of the active layer to an uppermost internal electrode of the lower cover layer.

7. The board having a multilayer ceramic capacitor of claim 5, wherein a ratio (B/A) of the sum (B) of the thicknesses of the lower cover layer and the identifying layer to ½ (A) of the overall thickness of the body exceeds 0.175 and is less than 0.38.

8. The board having a multilayer ceramic capacitor of claim 5, wherein a thickness from the active layer to an internal electrode positioned in a lowermost portion of the lower cover layer is smaller than a width of the body.

9. A multilayer ceramic capacitor comprising:
a body including an active layer in which first and second internal electrodes are alternately stacked with respective dielectric layers interposed therebetween, an upper cover layer formed on the active layer, a lower cover layer formed beneath the active layer and having a thickness greater than that of the upper cover layer, and an identifying layer formed beneath the lower cover layer,
wherein the lower cover layer includes third and fourth internal electrodes alternately stacked with the respective dielectric layers interposed therebetween, and
wherein C>F>G>E in which C is ½ of the overall thickness of the active layer, E is a thickness of a region in which the internal electrodes are formed in the lower cover layer, F is a thickness from a lowermost internal electrode of the lower cover layer to a lower surface of the identifying layer, and G is a thickness from a lowermost internal electrode of the active layer to an uppermost internal electrode of the lower cover layer.

10. The multilayer ceramic capacitor of claim 9, wherein a ratio (B/A) of the sum (B) of the thicknesses of the lower cover layer and the identifying layer to ½ (A) of the overall thickness of the body exceeds 0.175 and is less than 0.38.

11. The multilayer ceramic capacitor of claim 9, wherein a thickness from the active layer to an internal electrode positioned in a lowermost portion of the lower cover layer is smaller than a width of the body.
